(19) United States
(12) Patent Application Publication
(10) Pub. No.: US 2011/0107143 A1
(43) Pub. Date: May 5, 2011

(54) CACHE SYSTEM

(75) Inventor: Hiroyasu NAKATSUKA, Kanagawa (JP)

(73) Assignee: RENESAS ELECTRONICS CORPORATION, Kanagawa (JP)

(21) Appl. No.: 12/938,942

(22) Filed: Nov. 3, 2010

(30) Foreign Application Priority Data
Nov. 5, 2009 (JP) 2009-254095

(51) Int. Cl. G06F 11/07

(52) U.S. Cl. 714/15; 714/E11.023

(57) ABSTRACT

A write-back cache system includes: a dirty bit section configured to store a dirty indication data indicating that cache data is in a dirty state; and an OR calculation circuit connected with a front-stage to the dirty bit section. The OR calculation circuit includes: a first input node configured to receive a write request signal indicating a write request of a cache data; a second input node configured to receive a correctable error determination signal of the cache data indicating that a correctable error is present in the cache data; and an output node configured to output a signal such that the dirty indication data is stored in the dirty bit section, when receiving at least, one of the write request signal and the correctable error determination signal.

### INCORPORATION BY REFERENCE

This patent application claims a priority on convention based on Japanese Patent Application No. 2009-254095 filed on Nov. 5, 2009. The disclosure thereof is incorporated herein by reference.

### TECHNICAL FIELD

The present invention relates to a cache system and a cache method using the cache system, and especially relates to a write-back type cache system and a cache method using the cache system.

### BACKGROUND ART

In recent years, attention is focused on a problem of a soft error in a computer system with increase of a capacity of a main memory and miniaturization in a semiconductor process. For this reason, an ECC (Error Check and Correct) circuit is provided for reliability improvement, to perform correction of a 1-bit error and only detection of multi-bit error in case of memory read.

However, when a memory data in which the 1-bit error has occurred, is left without being corrected, there is a possibility that the 1-bit error of the memory data changes into the multi-bit error. Accordingly, for the purpose of reliability improvement, a system is required which can prevent generation of the multi-bit error by performing correction of the memory data with the 1-bit error.

In conjunction with the above-mentioned description, Patent Literature 1 (JP-A-Heisei 5-158809) discloses a memory error automatic correction data writing system. In a memory error automatic correction data writing system, a data read from a memory is corrected and written to a memory. The memory error automatic correction data writing system includes a 1-bit error detecting circuit for detecting a 1-bit error of data read from a memory; an address latch for latching an address for the data with the 1-bit error; and a correction circuit for correcting the 1-bit error of the data. When the 1-bit error-detection circuit detects the 1-bit error of data block read from a memory, the correction circuit performs a correction of the 1-bit error and outputs the corrected data. Also, the address latch latches an address for the data in which the 1-bit error is detected, and after read of a data block, the data which address is the same as the stored address is corrected by the correction circuit and written to the memory.

Also, Patent Literature 2 (JP-A-Heisei 10-83357) discloses a data storage control method. The data storage control method is used in a computer system including: a CPU having an external bus interface for burst transfer of data in consecutive addresses; a main memory unit; and an ECC executing section for performing error detection and correction of data. In the data storage control method, a read request is issued from the CPU to the main memory unit. When the ECC executing section detects that the read data has an error, an address for the read data is latched and interrupt information is held and an interrupt request is issued to the CPU. The CPU is set to an interruption inhibition state in an interrupt processing routine. A plurality of data which only subsequent address is different from latched address are read from the main memory unit and errors of these data are corrected by the ECC executing section. The corrected data are written to the main memory unit. Then, the interrupt information, is cleared and the CPU is set to an interrupt permission state.

### Citation List:

[Patent Literature 1]: JP-A-Heisei 5-158809

[Patent Literature 2]: JP-A-Heisei 10-83357

### SUMMARY OF THE INVENTION

In the memory error automatic correction data writing system according to the Patent Literature 1, read and correction write is always executed in a cycle next to a read cycle in which an error is detected. Accordingly, when a consecutive read request is issued, a system performance is degraded. In addition, although it is required to latch error addresses, the maximum latch number of addresses, that is, the maximum error number cannot be determined in advance. For this reason, a trade-off between the performance and a chip area will occur so that the effect is varied, depending on the latch number of addresses.

More in detail, in the Patent Literature 1, the memory error automatic correction data writing system according to the Patent Literature 1 retains an address in the address latch, and carries out the error correction to the data of retained address. In this manner, the correction possible number of errors at one time is determined depending on the address retention number. In addition, the Patent Literature 1 focuses on performance improvement of a memory block read cycle, but since a write request for error correction is postponed to the next cycle, there is a restriction that the postponing influences on the next cycle.

In a data storage control method according to the Patent Literature 2, when the error correction is carried out, an interrupt request is issued to a CPU and the error correction is carried out in the interruption processing routine of the CPU. Accordingly, there is a problem that the method can be used only in a system having the CPU with an interruption processing function. When a DMA unit is connected, the DMA unit is required to be stopped, and the influence might extend depending on a unit connected to a system bus. In this manner, the control of system will be complicated, and accordingly it would be difficult to realize the system.

The problem of the Patent literature 2 will be further described in detail. Since the data storage control method according to the Patent Literature 2 is a control system for carrying out the error correction in the interruption processing routine of the CPU, the interruption processing function is essential. In addition, a unit not under the control of the CPU is required to separately carry out controls of a DMA stop by using the interruption as a trigger. For this reason, the Patent Literature 2 has a restriction that there are required conditions to realize the control method according to the Patent Literature 2.

In an aspect of the present invention, a write-back cache system includes: a dirty bit section configured to store a dirty indication data indicating that cache data is in a dirty state; and an OR calculation circuit connected with a front-stage to the dirty bit section. The OR calculation circuit includes: a first input node configured to receive a write request signal indicating a write request of a cache data; a second input node configured to receive a correctable error determination signal of the cache data indicating that a correctable error is present in the cache data; and an output node configured to output a signal such that the dirty indication data is stored in the dirty bit section when receiving at least one of the write request signal and the correctable error determination signal.

In another aspect of the present invention, a cache method in a write-back system, includes: receiving a write request signal indicating a write request of a cache data; receiving a correctable error determination signal of the cache data indicating that a correctable error is present in the cache data; and generating a signal such that the dirty indication data is stored in the dirty bit section when receiving at least one of the write request signal and the correctable error determination signal.

In the present invention, a correctable error occurrence condition is newly provided as an additional condition to a block to which a dirty determining process is executed. In this manner, it is possible to write back a corrected data into a main memory in association with a fundamental write-back operation.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram showing a configuration of a cache system according to a first embodiment of the present invention;

FIG. 2 is a block diagram showing detailed configuration of a cache, a DRAM controller, and a DRAM according to the first embodiment of the present invention;

FIG. 3 is a flowchart showing an operation of the cache system according to the present invention;

FIG. 4 is a flowchart showing an operation of the cache systems according to the present invention;

FIG. 5 is a block diagram showing a configuration of the cache system according to a second embodiment of the present invention; and

FIG. 6 is a block diagram showing the detailed configuration of the two caches, a DRAM controller, and a DRAM according to the second embodiment of the present invention.

### DESCRIPTION OF EMBODIMENTS

Hereinafter, a cache system according to the present invention will be described with reference to the attached drawings.

### First Embodiment

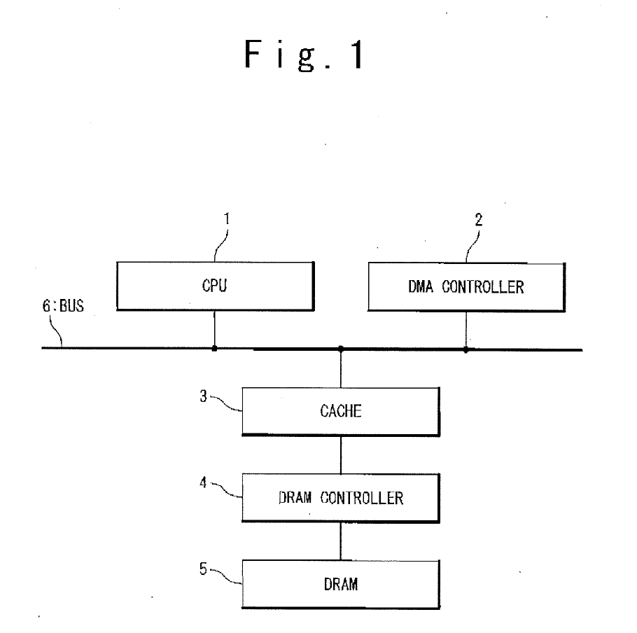

In a first embodiment of the present invention, a case where a CPU 1 is of a single-core type will be described. FIG. 1 is a block diagram showing the configuration of a cache system according to the present embodiment. The cache system includes a CPU 1, a DMA controller 2, a cache 3, a DRAM controller 4, a DRAM 5 as a main memory, and a bus 6.

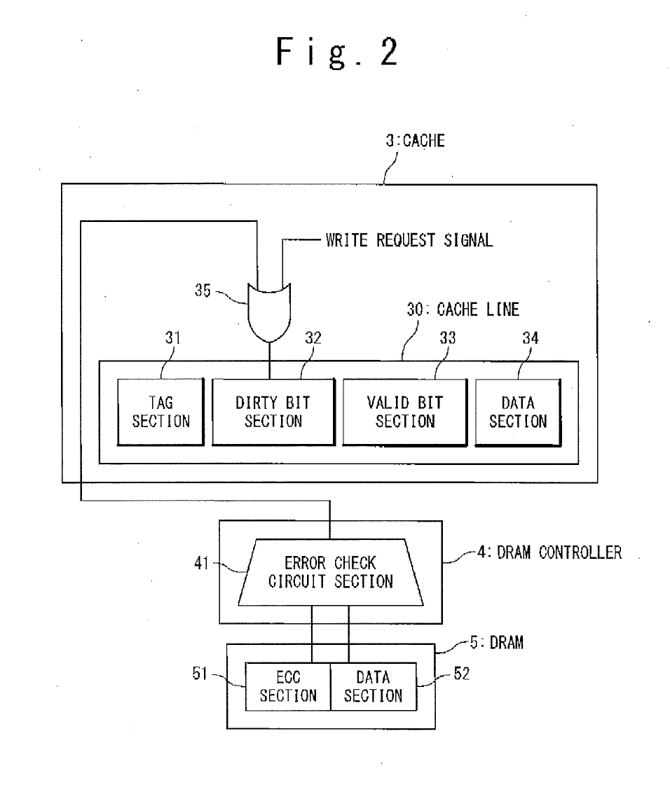

FIG. 2 is a detailed block diagram shoving the configurations of the cache 3, the DRAM controller 4, and the DRAM 5 according to the present embodiment. The cache 3 includes cache lines 30 and an OR calculation circuit 35. The number of cache lines 30 may be one or more. The cache line 30 includes a tag section 31, a dirty bit section 32, a valid bit-section 33, and a data section 34. The DRAM controller 4 includes an error check circuit 41. The DRAM 5 includes an ECC section 51 and a data section 52.

The respective sections in the cache line 30 will be described. When the cache line 30 caches a data as a cache data, a main body of the cache data is stored in the data section 34. An address of the DRAM 5 at which the cache data is stored is stored in the tag section 31.

The dirty bit section 32 stores a 1-bit data indicating whether the cache data stored in the data section 34 is in “dirty” state or in “clean” state. It should be noted that when the cache data stored in the data section 34 is the same as an original data stored in the DRAM 5, the cache data is in the “clean” state, and when the data has been updated and changed, the cache data is in the “dirty” state.

The valid bit section 33 stores a 1-bit data indicating whether the cache data stored in the data section 34 is in a “valid” state or in an “invalid” state. It should be noted that the “valid” state means that a valid cache data is stored in the data section 34, and the “invalid” state means the opposite state.

Next, a connection relation between the respective components in the cache system according to the present embodiment will be described.

The bus 6 is connected to the CPU 1, the DMA controller 2, and the cache 3. The cache 3, the DRAM controller 4, and the DRAM 5 are connected in series in this order.

An output node of the ECC section 51 and an output node of the data section 52 are connected to first and second input nodes of the error check circuit 41, respectively. An output node of the error check circuit 41 is connected to a first input node of the OR calculation circuit 35. A write request signal is connected to a second input node of the OR operation section 35. An output node of the OR calculation circuit 35 is connected to an input node of the dirty bit section 32.

Essential components in the cache system according to the present embodiment have been described above. Other connection relations between the components are required as in a general cache system, but the detailed description will be omitted since they are not directly related to the present invention.

As described above, the CPU 1 cannot directly access the DRAM 5. That is, in order for the CPU 1 to access the DRAM 5, it is always necessary to access the DRAM through, the cache 3 in both cases of read and write.

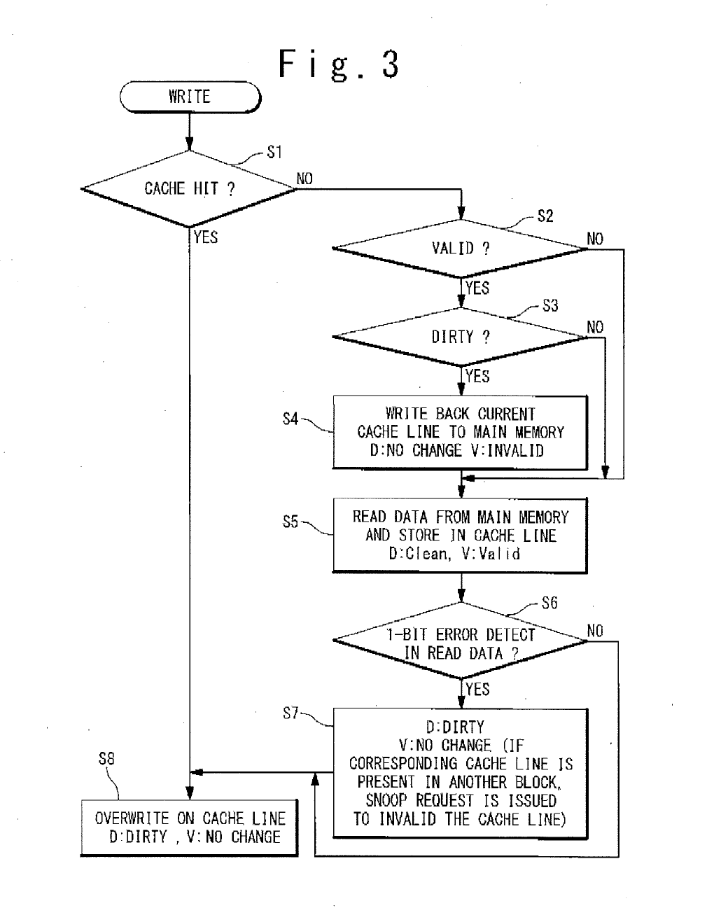

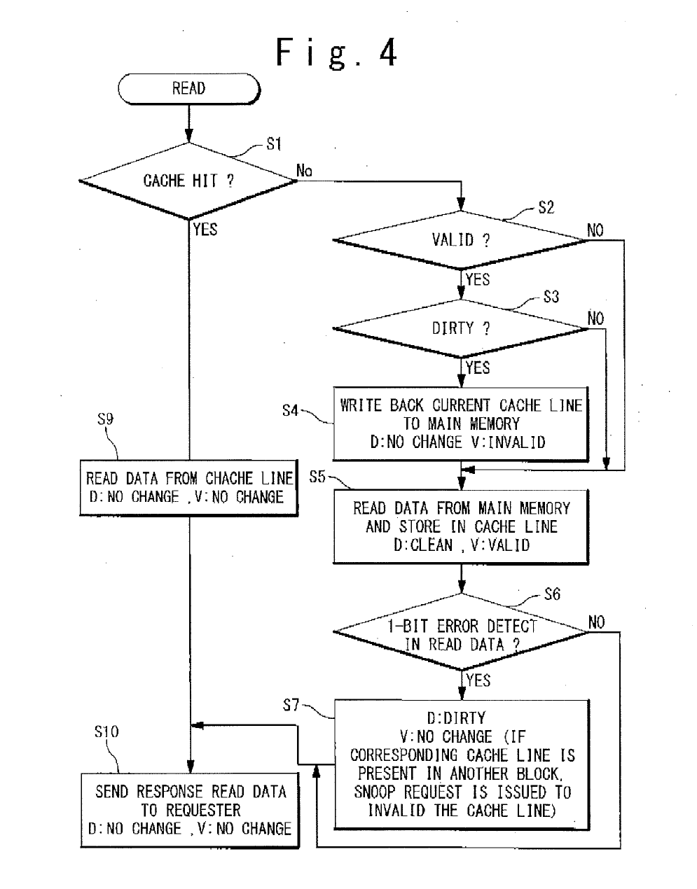

FIGS. 3 and 4 are flowcharts showing an operation of the cache system according to the present embodiment. At first, referring to FIG. 3, an operation when the write request signal is supplied to the OR calculation circuit 35, that is, a write operation will be described.

The flowchart of the write operation according to the present embodiment includes steps S1 to S8.

Firstly, at a step S1, it is determined whether or not a cache hit has occurred. When the cache hit has not occurred, that is, when the cache miss has occurred (NO), the control flow advances to a step S2. When the cache hit has occurred (YES), the control flow advances to a step S8.

At the step S2, the bit data stored in the valid bit section 33 is determined. When the bit data in the section 33 indicates the valid state (YES), the control flow advances to a step S3. When the bit data in the section 33 indicates the invalid state (NO), the control flow advances to a step S5.

At the step S3, the bit data stored in the dirty bit section 32 is determined. When the bit data in the dirty bit section 32 indicates the dirty state (YES), the control flow advances to a step S4. When the bit data in the dirty bit section 32 indicates the clean state (NO), the control flow advances to a step S5.

At the step S4, a write-back operation is performed. Specifically, an operation to write back data stored in the current cache line 30 into the DRAM 5 as the main memory is performed. At this time, the bit data in the dirty bit section 32 is left without any change. In addition, the bit data in the valid bit section 33 is set to the invalid state. Then, the control flow advances to the step S5.

At the step S5, the data written into the DRAM 5 as the main memory is read from the DRAM 5 as the main memory, and is stored in the cache line 30. At this time, the bit data in the dirty bit section 32 is set to be clean. In addition, the state of the valid bit section 33 is set to the valid state. After that, the control flow advances to a step S6.

At the step S6, when the read is performed at the step S5, it is determined whether or not the 1-bit error has occurred in the read data. When the 1-bit error has occurred (YES), the control flow advances to step S7. When the 1-bit error has not occurred (NO), the control flow advances to the step S8.

At the step S7, the dirty bit section 32 is set to the dirty state. In addition, the valid bit section 33 is left without any change. It should be noted that, since it is supposed in the present embodiment that the CPU 1 is the single-core, an operation to another block is not performed. After that, the control flow advances to the step S8.

At the step S8, the content of the cache line 30 is updated, and the dirty bit section 32 is set to the “dirty” state. It should be noted that the valid bit section 33 is left without any change.

Next, an operation when a read request is issued in the present embodiment will be described with reference to FIG. 4.

Firstly, at the step S1, it is determined whether or not the cache hit occurred. When the cache hit has not occurred (NO), the control flow advances to the step S2. When the cache hit has occurred (YES), the control flow advances to a step S9.

The steps S2 to S5 are the same as those of FIG. 3 in case of write, and the detailed description is omitted.

At the step S6, when the read is performed at the step S5, it is determined whether or not the 1-bit error has occurred in a read data. When the 1-bit error has occurred (YES), the control flow advances to a step S7. When the 1-bit error has not occurred (NO), the control flow advances to a step S10.

At the step S7, the dirty bit section 32 is set to the dirty state. In addition, the valid bit section 33 is left without any change. It should be noted that if the corresponding cache line exists in another block, a snoop request is issued, and the valid bit section 33 in the cache line is set to an invalid state. After that, the control flow advances to the step S10.

At a step S9, a data is read from the data section 34 of the cache 3. At this time, the dirty bit section 32 and the valid bit section 33 are left without any change. After that, the control flow advances to the step S10.

At the Step S10, the read data is returned to the requester. At this time, the dirty bit section 32 and the valid bit section 33 are left without any change.

As described above, according to the present embodiment, when the read data has a 1-bit correctable error in the storage of the read data, from the DRAM 5 as the main memory into the cache line 30, the dirty bit section 32 is set to the dirty state. In this manner, when a cache miss has occurred in the same cache line 30 for next time, the write-back process of corrected data existing in the cache line 30 is executed in association with the write-back operation for writing back the contents of the cache line 30 into the DRAM 5 as the main memory.

### Second Embodiment

In a second embodiment of the present, invention, a case that CPU is of multi-core to have CPUs 1-1 and 1-2 will be described.

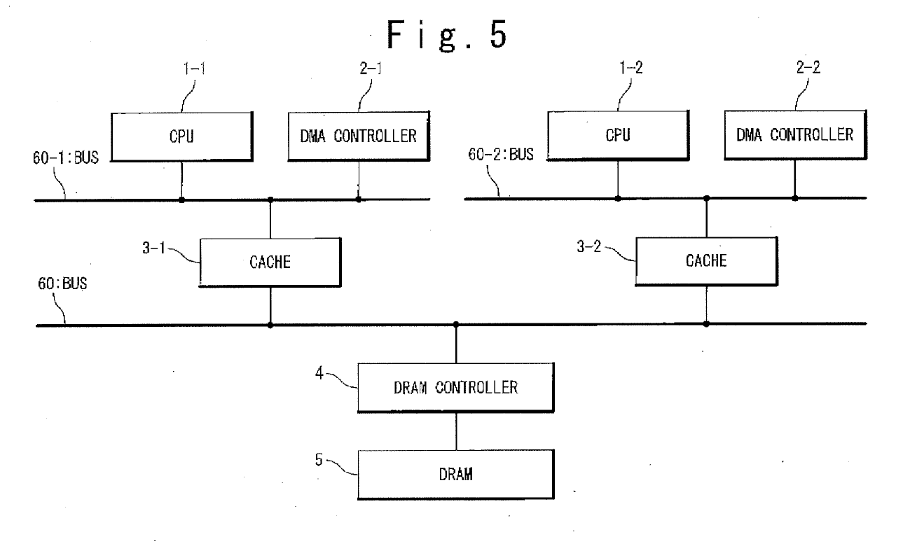

FIG. 5 is a block diagram showing a configuration of the cache system according to the present embodiment. The cache system includes the first and second CPUs 1-1 and 1-2, first and second DMA controllers 2-1 and 2-2, first and second caches 3-1 and 3-2, the DRAM controller 4, the DRAM 5, and three busses 60, 60-1, and 60-2.

It should be noted that the configuration of the cache system shown in FIG. 5 is employed when the CPU is of multi cores CPUs 1-1 and 1-2, and the cache system according to the present embodiment can be attained even in a case of the multi-core of many CPUs. However, in this case, it is needless to say that a total number of the DMA controllers, the caches, and the buses need to be arbitrarily increased and decreased depending on the total number of the CPUs. Here, the case of two CPUs 1-1 and 1-2 will be described.

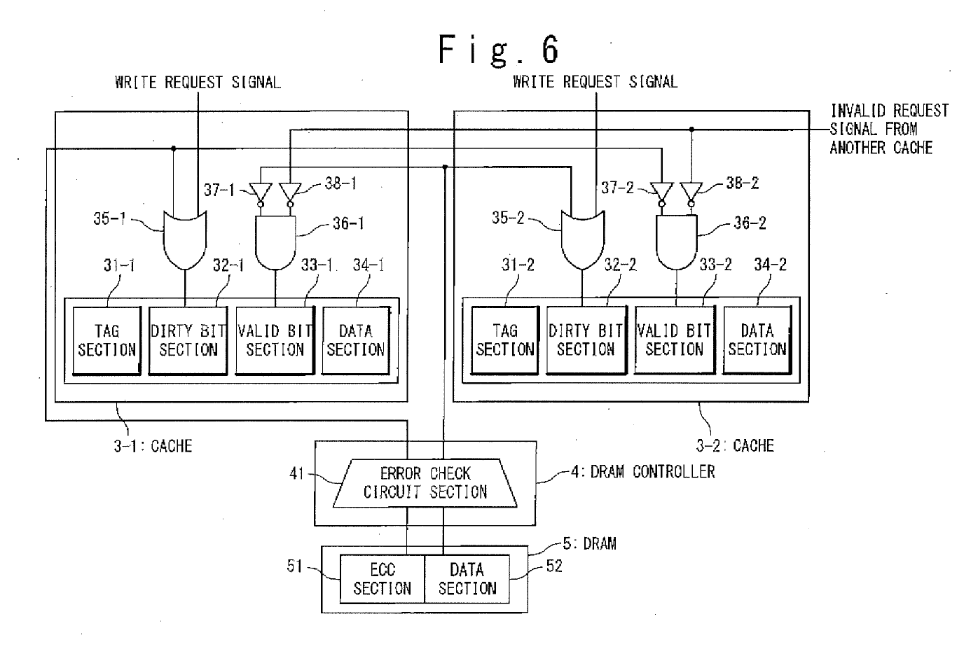

FIG. 6 is a block diagram showing detailed configuration of the two caches 3-1 and 3-2, the DRAM controller 4, and the DRAM 5 according to the present embodiment.

The first cache 3-1 includes a first cache line 30-1, a first OR calculation circuit 35-1, a first AND calculation circuit 36-1, and two NOT calculation circuits 37-1 and 38-1. The number of the first cache lines 30-1 may be one or more. Each first cache line 30-1 includes a first tag section 31-1, a first dirty bit section 32-1, a first valid bit section 33-1, and a first data section 34-1.

The second cache 3-2 includes a second cache line 30-2, a second OR calculation circuit 35-2, a second AND calculation circuit 36-2, and two NOT calculation circuits 37-2 and 38-2. The number of second cache lines 30-2 may be one or more. Each second cache line 30-2 includes a second tag section 31-2, a second dirty bit section 32-2, a second valid bit section 33-2, and a second data section 34-2.

The DRAM controller 4 includes the error check circuit 41. The DRAM 5 includes the ECC section 51 and the data section 52.

Then, a connection relation between the respective components in the cache system according to the present embodiment will be described.

The bus 60-1 is connected to the first CPU 1-1, the first DMA controller 2-1, and the first cache 3-1. The bus 60-2 is connected to the second CPU 1-2, the second DMA controller 2-2, and the second cache 3-2. The bus 60 is connected to the first cache 3-1, the second cache 3-2, and the DRAM controller 4. The DRAM controller 4 is connected to the DRAM 5.

An output node of the ECC section 51 and an output node of the data section 52 are connected to the first and second input nodes of the error check circuit 41, respectively. A first output node of the error check circuit 41 is connected to a first input node of the first OR calculation circuit 35-1 and to an input node of the NOT calculation circuit 37-2 of the second cache 3-2. A second output node of the error check circuit 41 is connected to an input node of the MOT calculation circuit 37-1 of the first cache 3-1 and to a first input node of the second OR calculation circuit 33-2. An invalid request signal from another cache (not shown) is connected to an input node of the NOT calculation circuit 38-1 of the first cache 3-1 and to an input node of the NOT calculation circuit 33-2 of the second cache 3-2.

The connection relation between the respective components in the first cache 3-1 will be described. A write request signal is connected to a second input node of the first OR calculation circuit 35-1. The output nodes of the two NOT calculation circuits 37-1 and 35-1 are connected to two input nodes of the first AND calculation circuit 36-1, respectively. The output node of the first OR calculation circuit 35-1 is connected to an input node of the dirty bit section 32-1. An output node of the first AND calculation circuit 36-1 is connected to an input node of the valid bit section 33-1.

The connection relation between the respective components in the second cache 3-2 will be described. A write request signal is connected to a second input node, of the second OR calculation circuit 35-2. Output nodes of the two NOT calculation circuits 37-2 and 32-2 are connected to two input nodes of the second AND calculation circuit 36-2, respectively. An output node of the second OR calculation circuit 35-2 is connected to an input node of the dirty bit section 32-2. An output node of the second AND calculation circuit 36-2 is connected to an input node of the valid bit section 33-2.

Of the connection relations between the respective components in the cache system according to the present, embodiment, essential components to perform the operation in the present embodiment have been described above. Some of other connection relations between the components are required as in a general cache system, but the detailed description will be emitted.

An operation of the cache system according to the present embodiment will be described. As an example, a case where a read request is issued to the first cache 3-1 will be described.

Even in the present embodiment, the write operation and the read operation are performed on the basis of the flowcharts shown in FIGS. 3 and 4, like the first embodiment of the present invention. Here, the cache line 30, the dirty bit section 32, and the valid bit section 33 in the first embodiment of the present invention need to be replaced by the cache line 30-1 or 30-2, the dirty bit section 32-1 or 32-2, and the valid bit section 33-1 or 33-2, respectively. Specifically, FIGS. 3 and 4 are flowcharts showing the operation of the cache system according to the present embodiment. However, the step S7 of the present embodiment is different from that of the first embodiment of the present invention.

In the write operation and the read operation according to the present embodiment, at the step S7, the dirty bit section 32-1 is firstly set to the dirty state, in the same manner as that of the first embodiment of the present invention. In addition, the valid bit section 33-1 is left without any change. It should, be noted that, if the corresponding cache line exists in another block, a snoop request is issued, and the valid bit section 33-1 in the cache, line is set to the invalid state. After that, the control flow advances to the step S8.

The respective steps other than the step S7 in the operation according to the present embodiment are the same as those of the first embodiment of the present invention, and accordingly the detailed description will be omitted.

As described above, in the present embodiment, the valid bit sections 33-2 in the other cache 3-2 other than the requester is set to the invalid state. Accordingly, when the read request is issued to the cache line 30-2 of the second cache 3-2 for next time, the write-back operation of the corrected data existing in the cache line 30-1 is performed in association with the write-back operation for writing back the contents or the cache line 30-1 of the first cache 3-1 into the DRAM 5 as the main memory, before the other cache 3-2 performs the memory read from the DRAM 5 as the main memory on the basis of the write-back method. After that, since the memory read from the DRAM 5 as the main memory is performed to the cache line 30-2 of the other cache 3-2, the corrected data is stored in the cache line 30-2 of the other cache 3-2.

Focusing on one of the plurality of caches 3-1 and 3-2, other operations are the same as those of the first embodiment of the present invention described with reference to FIGS. 3 and 4. In other words, in the plurality of caches 3-1 and 3-2, the operations based on the flowcharts of FIGS. 3 and 4 can be independently performed.

Accordingly, the cache system according to the present invention easily increases a total number of caches to three or more. However, it is needless to say that the number of the output nodes of the error check circuit 41, of the input nodes of the AND calculation circuits 36-1 and 36-2, and of the NOT calculation circuits 37-1, 37-2, 38-1, and 38-2 connected to the input nodes of the AND calculation circuits 36-1 and 36-2 need to be increased and decreased depending on the increase and decrease of the total number of the caches.

The cache system according to the present embodiment also can be applied to the multi-core configuration employing the write-back method by only adding the AND calculation circuits 36-1 and 36-2 connected to the valid bit sections 33-1 and 33-2 to the cache system according to the first embodiment of the present invention. In addition, it is not required to correct a complicated cache algorithm itself of the multi-core configuration, and the write-back of the ECC correction data can be realized by a simply-corrected content that is only a writing condition to the valid bit sections 33-1, and 33-2.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A write-back cache system comprising:
a dirty bit section configured to store a dirty indication data indicating that cache data is in a dirty state; and
an OR calculation circuit connected with a front-stage to said dirty bit section,
wherein said OR calculation circuit comprises:
a first input node configured to receive a write request signal indicating a write request of a cache data;
a second input node configured to receive a correctable error determination signal of said cache data indicating that a correctable error is present in said cache data; and
an output node configured to output a signal such that the dirty indication data is stored in said dirty bit section when receiving at least one of said write request signal and said correctable error determination signal.

2. The cache system according to claim 1, further comprising:
a valid bit section configured to store a 1-bit data indicating that said cache data is in a valid state;
an AND calculation circuit connected with a front-stage to said valid bit section,
wherein said AND calculation circuit comprises:
a first input node configured to receive an invalid request signal based on another cache data other than said cache data;
a second input node configured to receive a correctable error determination signal of said anther cache data indicating that there is a correctable error in said another cache data; and
an output node configured to output a signal such that the invalid indication data is stored in said valid bit section when receiving at least one of said invalid request signal and the correctable error determination signal of said another cache data.

3. A cache method in a write-back system, comprising:
receiving a write request signal indicating a write request of a cache data;
receiving a correctable error determination signal of said cache data indicating that a correctable error is present in said cache data; and
generating a signal such that the dirty indication data is stored in said dirty bit section when receiving at least one of said write request signal and said correctable error determination signal.

4. The cache method according to claim 3, further comprising:
receiving an invalid request signal based on another cache data other than said cache data;
receiving a correctable error determination signal of said another cache data indicating that there is a correctable error in said another cache data; and
generating a signal such that the invalid indication data is stored in said, valid bit section when receiving at least one of said invalid request signal and the correctable error determination signal of said another cache data.
